(19) United States
(12) Patent Application Publication
(10) Pub. No.: US 2011/0270701 A1
(43) Pub. Date: Nov. 3, 2011

(54) DISPLAYING ACTIVE RECENT BIDDERS IN A BIDDING FEE AUCTION

(76) Inventors: Benjamin Joseph Black, Seattle, WA (US); Maxwell Robert Newbould, Woodland Hills, CA (US); Andrew Frame, Los Angeles, CA (US); Babe Elliott Baker, Santa Monica, CA (US)

(21) Appl. No.: 12/786,376

(22) Filed: May 24, 2010

Related U.S. Application Data
(60) Provisional application No. 61/330,279, filed on Apr. 30, 2010.
(60) Provisional application No. 61/333,219, filed on May 10, 2010.

(51) Int. Cl. G06Q 30/00

(52) U.S. Cl. 705/26.3

(57) ABSTRACT

In one embodiment, active recent bidders in a bidding fee auction are displayed in a region of a graphical bidder interface. Each bidder in the set of active recent bidders is displayed in a single graphical bidder element, or avatar, in the region. In response to receiving an event, an activity level and a recency measure for each bidder in the bidding fee auction are generated. Bidders are removed or added to the set of active recent bidders based on the activity levels and recency measures of the bidders. Avatars corresponding to the bidders are added or removed from the region.

This application claims priority to U.S. Provisional Application No. 61/330,279, filed on Apr. 30, 2010, and also claims priority to U.S. Provisional Application No. 61/333,219, filed on May 10, 2010 and incorporated herein by reference in its entirety.

### FIELD OF THE INVENTION

Embodiments of the invention are generally directed toward displaying a bidding interface for an online bidding auction. More specifically, embodiments of the invention are directed toward displaying active recent bidders in a bidding fee auction.

### BACKGROUND

A bidding fee auction, also called a penny auction, is a type of auction in which participants must pay a non-refundable fee to place a small incremental bid. Each bid causes the remaining time for the auction to increase by a predetermined amount of time. When time expires, the last participant to have placed a bid wins the item and also pays the final bid price, which is usually significantly less than the retail price of the item. The item up for bid may be a physical product such as a video game system or portable music player. The item up for bid may also be a service, such as a musical concert.

Each bid increments the item price by a given amount, such as one cent. Bidders are users participating in the auction by submitting bids for the good being auctioned. A current winner of an auction is generally the most recent bidder to submit a bid and is thus currently winning the auction.

In addition to a current winner, a list of recent bidders can be displayed. The list is updated as bids are submitted. If a large number of bids are received in a short period of time (i.e., a high bid volume), the list of recent bidders is updated so rapidly as to degrade its usefulness, since entries are not displayed in the list of recent bidders long enough for a bidder participating in the auction to view and digest the information.

### SUMMARY

In one embodiment, active recent bidders in a bidding fee auction are displayed in a region of a graphical bidder interface. Each bidder in the set of active recent bidders is displayed in a single graphical bidder element, or avatar, in the region. In response to receiving an event, an activity level and a recency measure for each bidder in the bidding fee auction are generated. Bidders are removed or added to the set of active recent bidders based on the activity levels and recency measures of the bidders. Avatars corresponding to the bidders are added or removed from the region.

### BRIEF DESCRIPTION OF THE DRAWINGS

The present invention is illustrated by way of example and not limitation in the Figures of the accompanying drawings in which like references indicate similar elements.

FIG. 1 is a diagram illustrating a graphical bidder interface for interacting with a bidding fee auction according to an embodiment of the invention;

FIG. 2A is a flow chart illustrating a method of updating a set of selected bidders according to an embodiment of the invention;

FIG. 2B is a flow chart illustrating a method of updating a set of active recent bidders according to an embodiment of the invention;

FIG. 2C is a flow chart illustrating a method of updating a set of active recent bidders according to an embodiment of the invention;

FIG. 3 is a flow chart illustrating a method of applying a set of membership transitions according to an embodiment of the invention;

FIG. 4 is a diagram illustrating evaluations of activity level and recency measure over time according to an embodiment of the invention;

FIG. 5 is a diagram illustrating an example of bidder evaluations according to an embodiment of the invention;

FIG. 6 is diagram illustrating bidder rankings according to an embodiment of the invention;

FIG. 7A is a diagram illustrating removal of bidders from a set of active recent bidders according to an embodiment of the invention;

FIG. 7B is a flow chart illustrating a method of determining whether to remove a bidder from a set of active recent bidders;

FIG. 7C is a flow chart illustrating a method of adding a current winner to the set of active recent bidders;

FIG. 7D is a flow chart illustrating a method of adapting removal of bidders from a set of active recent bidders based on a measure of churn according to an embodiment of the invention;

FIG. 8 is a diagram illustrating a set of membership transitions according to an embodiment of the invention;

FIG. 9 is a flow chart illustrating a method of applying a set of membership transitions according to an embodiment of the invention;

FIG. 10 is a diagram of a data processing system that may be used with embodiments of the invention; and

FIG. 11 is a diagram of a device that may be used with embodiments of the invention.

FIG. 12 is a diagram illustrating a linear embodiment of an active recent bidder region;

FIGS. 13 and 14 are diagrams illustrating radial embodiments of an active recent bidder region;

FIGS. 15-18 are diagrams illustrating various linear embodiments of an active recent bidder region;

FIG. 19 is a diagram illustrating various orderings of linear embodiments of an active recent bidder region;

FIG. 20 is a diagram illustrating a linear embodiment of an active recent bidder region with a distinguished leader; and

FIGS. 21A-21D are diagrams illustrating various orderings of radial embodiments of an active recent bidder region.

FIG. 22 is a diagram illustrating modules of an embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

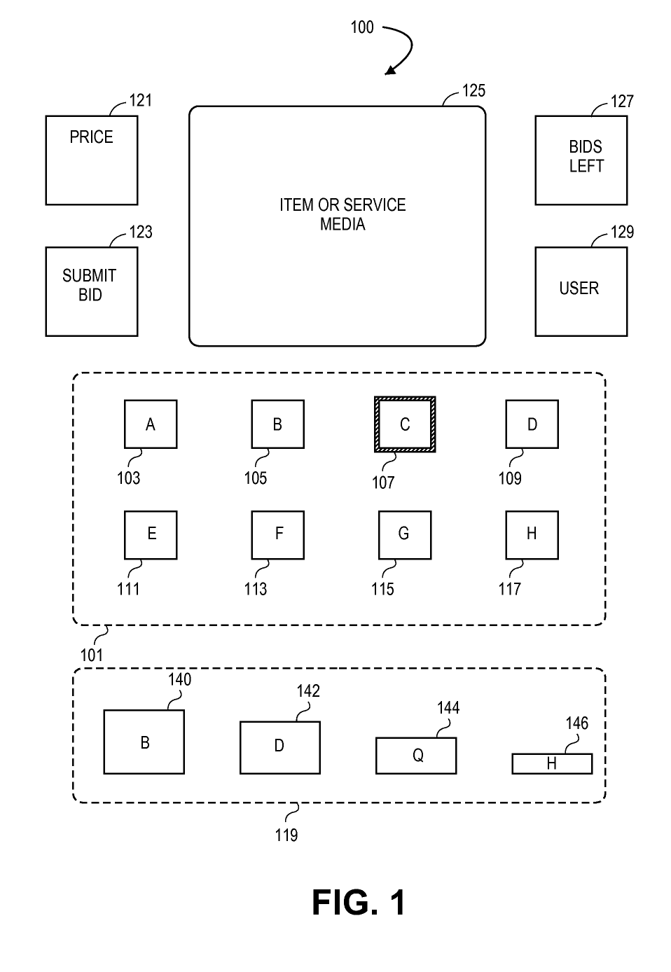

FIG. 1 illustrates a graphical bidder interface 100 for an online bidding fee auction according to an embodiment of the invention. Other embodiments of the invention may be used to conduct other types of auctions other than bidding fee auctions. The graphical bidder interface 100 includes the active recent bidders region 101, which displays a representation of active recent bidders for the good or service being auctioned (represented by the good or service media item 125). The good or service being auctioned may be referred to as an “item up for bid.” The item up for bid may be a one-of-a-kind item, such as a special music concert, a Picasso painting, etc. Each bid has a cost which may be referred to as a “per bid fee.” The per bid fee may be a dollar or a different value. The per bid fee is not necessarily related to the price increment associated with a bid. An auction may have an expected number of bids before completion. The expected number of bids may be quite high if the item up for bid is a one-of-a-kind item, and may cause the expected number of bids to exceed one thousand. The rate at which bids are received may exceed the ability to display a bid history in a reasonably viewable manner.

As illustrated, the active recent bidders region 101 includes the bidder elements 103 through 117. Each of these bidder elements corresponds to a single member of a set of active recent bidders and optionally provides a visual representation of the bidder. Thus, the bidders that correspond with the bidder elements 103 through 117 have each bid for the good or service being auctioned. It should be understood that there may be other bidders who have bid on the good or service which are not represented in the active recent bidders region 101 (e.g., they do not qualify as active recent bidders). Each bidder element may be an animation, a static graphic, text, or other media content, or any combination thereof. As used herein, the visual representation of a bidder element is referred to as an “avatar.”

The active recent bidders region 101 includes one or more bidder elements that correspond to the one or more bidders that are currently winning the auction. In some embodiments, the bidder element(s) of the current winner(s) are visually distinguished in the active recent bidders region 101. For example, in some embodiments, the currently winning bidder(s) are represented by a visual modification of the corresponding bidder element(s) (e.g., highlighting those bidder element(s), changing the color of those bidder element(s), increasing the relative size of those bidder element(s), changing the color of the other bidder element(s) (those that are not currently winning), decreasing the size of other bidder element(s), etc.) and/or by position in the active recent bidders region 101. As illustrated in FIG. 1, the highlighting around bidder element 107 indicates that the corresponding bidder is a current winner of the bidding fee auction (thus is currently winning the auction).

In some embodiments, there are a maximum number of bidder elements that can be displayed in the active recent bidders region 101. The maximum number may be different depending on the type of good or service being auctioned. The maximum number may also be different based on the client application accessing the graphical bidder interface 100. For example, there may be a custom interface for accessing the graphical bidder interface 100 through a mobile phone, or other device with a limited viewing area, that has a smaller maximum number of bidder elements as compared with accessing the graphical bidder interface 100 through a computing device with a larger viewing area (e.g., a desktop, laptop, workstation, etc.). In some embodiments, the maximum number may change during the lifetime of the auction. For example, there may be a relatively smaller number of bidder elements that can be displayed in the active recent bidders region 101 when the auction is nearing completion as compared to other times in the auction.

It should be understood that the size, shape, and location of the active recent bidders region 101 in the interface 100 as illustrated in FIG. 1 is exemplary and other sizes, shapes, and locations are possible. In some embodiments, the shape of the active recent bidder region 101 is based on the good or service being auctioned. By way of example, if concert tickets are being auctioned, the shape and location of the active recent bidder region 101 may approximate virtual concert seating (thus the bidder elements may visually appear as being in the audience of the concert and the current winner(s) may appear to have the best seat(s) (e.g., front row seats)). As another example, if sporting tickets are being auctioned, the shape and location of the active recent bidder region 101 may approximate stadium seating.

The graphical bidder interface 100 also includes the bidder volume region 119 (which is optional) that indicates the bidder(s) that have submitted the most number of bids during the auction. As illustrated in FIG. 1, the bidding volume region 119 includes the bidder elements 140, 142, 144, and 146. The bidder elements 140-146 represent the bidders that currently have submitted the most number of bids during the auction. The bidder(s) that are represented in the bidder volume region 119 are not necessarily represented in the active recent bidders region 101. For example, the bidder element 144, which corresponds with bidder Q, is not currently represented on the active recent bidders region 101. In one embodiment, the visual representation of a bidding element in the bidder volume region 119 is the same as it would be in the active recent bidders region 101.

While in one embodiment, the relative size of each bidding element in the bidder volume region 119 indicates the relative number of bids submitted by the corresponding bidder, in other embodiments the relative number of bids is displayed differently (e.g., different colors, different positions in the bidding volume region 119, etc.). As illustrated in FIG. 1, the bidding element 140, which corresponds with bidder B, currently has submitted the most number of bids for the auction as indicated by its relative size being greater than the bidding elements 142, 144, and 146. The bidding volume region 119 may also display the total number of bids of each of the bidders represented in the bidding volume region (e.g., near the corresponding bidding element).

Although FIG. 1 illustrates four bidding elements in the bidding volume region 119, it should be understood that the maximum number of displayable bidding elements in the bidding volume region 119 can be different. In addition, the maximum number of displayable bidding elements in the bidding volume region 119 can be different than the maximum number of displayable bidding elements in the active recent bidders region 101. The maximum number of displayable bidding elements in the bidding volume region 119 may also be different based on the client application accessing the graphical bidder interface 100 in a similar way as described with reference to the active recent bidders region 101.

The graphical bidder interface 100 also includes the price object 121, the submit bid interface 123, the bids left object 127, and the user object 129. The price object 121 displays the current bid price of the item or service being auctioned. The submit bid interface 123, when selected by a bidder, submits a bid for the good or service being auctioned. The remaining bids object 127 indicates how many bids the bidder has left to submit (in some embodiments the bidder is required to pre-purchase bids). In one embodiment, an interface is available which allows the bidder to purchase additional bids. The user object 129 is a media element that displays text, graphics, or video representing a bidder using the interface displayed in FIG. 1 to participate in the auction, and is similar to the avatars representing the bidding elements. The good or service media 125 is a graphical representation of the good or service currently being auctioned. Media 125 may be text, video, audio, graphics, or other type of media. In one embodiment, each bidder participating in the auction is shown their own avatar in the user object 129. The graphical bidder interface may also include a time remaining display (not shown). The time remaining display indicates the remaining time left in the auction. A submitted bid may cause the time remaining in the auction to increase. The change to the time remaining in the auction may change depending on characteristics of the auction. For example, the amount of time added to the auction in response to a bid may decrease as the total duration of the auction increases. A two day old auction may add twenty seconds to the remaining time in response to a bid, while a four day old auction may add ten seconds to the remaining time in response to a bid. Other characteristics of the auction may also be used to modify the time added, such as current price, number of active recent bidders, etc.

In the embodiment illustrated in FIG. 1, the bidder represented by the user object 129 submits bids for the auction by using the submit bid interface 123. As the bidder represented by the user object 129 bids, the remaining bids 127 decreases. As the bidder represented by the user object 129 and other bidders submit bids for the auction, the price 121 will increase, and the elements in the bidder volume region 119 and the elements in active recent bidder region 101 may be updated. For example, if the bidder qualifies for display in active recent bidder region 101, avatar 129 may be displayed in active recent bidder region 101. If, after being displayed in active recent bidder region 101, the bidder becomes disqualified from membership in the active recent bidder region 101, avatar 129 will be removed from active bidder region 101. As the bidder represented by avatar 129 and other bidders submit further bids in the auction, the size and set of members of the bidder volume region 119 may also be changed.

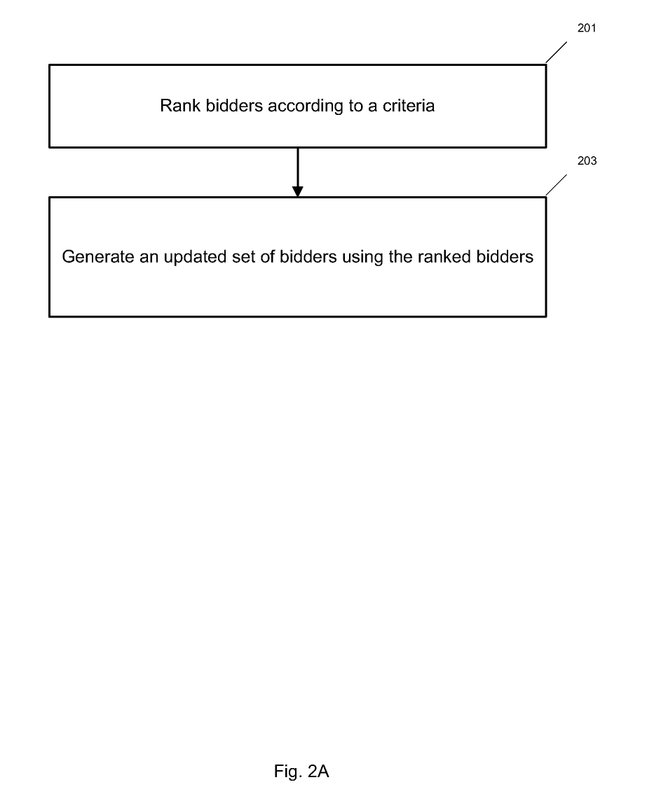

Membership of bidders in the set of active recent bidders is described in greater detail below in conjunction with FIGS. 2A-2C. FIG. 2A is a flow chart illustrating a method of updating a set of selected bidders. At block 201, the method ranks each bidder in an auction according to a criteria. Different criteria may be used. FIG. 2B illustrates a method using a bid recency criteria to rank the bidders. FIG. 2C illustrates a method using bid activity and bid recency criteria to rank the bidders. Other criteria may be used as well.

At block 203, the method generates an updated set of bidders using the ranked bidders. The updated set of bidders may correspond to the avatars displayed in the active bidder region 101 of FIG. 1. The quantity of bidders in the set of bidders may be modified according to auction type, popularity, etc. For example, the set of bidders at the beginning of an auction may have zero members. As unique bidders join the auction, the size of the set may grow until a threshold is reached. For example, the threshold may be 10 bidders. After the threshold is met, membership of the set changes based on the ranking of bidders at block 201, but the size of the set remains the same. In some embodiments, the size of the set may decrease if the number of bidders participating in the auction is reduced. For example, if the current size of the set is 10 bidders, but only 5 bidders have bid in a time period (e.g., the last 5 minutes), the size of the set may be reduced to give more prominence to the remaining bidders in the auction.

In one embodiment, bidders participating in an auction may be bundled into separate groups according to criteria. For example, bidders may be grouped by the aggressiveness with which they bid. Suppose an auction has thirty participating bidders, where a participating bidder is a bidder that has submitted a bid at some point during the auction. Five of the thirty bidders are aggressive bidders and submit bids every minute or less. The remaining twenty-five bidders submit bids more than a minute apart. The aggressive bidders may be grouped into an aggressive bundle and the remaining twenty-five bidders may be grouped into a standard bundle.

As a result of the bundling, the aggressive bidders see bidders from the aggressive bundle in the user interface. The aggressive bidder bundle may be represented in the active bidder region and the bidder volume region. Alternatively, the active bidder region may be filtered by the bundles while the bidder volume draws members from all participating bidders. In some embodiments, the current winner is displayed in the active bidder region regardless of the bundle to which the current winner belongs. Other criteria may be used to bundle the bidders, such as geographic location, type of membership (e.g., premium or standard), etc. In another embodiment, bidders are bundled as they join the auction. If the current bundles are full at the time a bidder joins, the bidder may be placed in a new bundle. The new bundle may have an initial membership drawn from other bundles. In some embodiments, bidders may be moved between bundles as the characteristics of the bidder changes. For example, if the behavior of a bidder currently in the aggressive bidder bundle fails to satisfy the aggressive bundle criteria, the bidder may be moved to a less aggressive bundle. In one embodiment, bundling may cause different sets of active recent bidders to be transmitted to bidders. Each bundle may be associated with a different set of active recent bidders. Bidders in a particular bundle may receive the set of active recent bidders corresponding to that particular bundle. In embodiments using different membership criteria and bundled bidders, the membership of the set of active recent bidders may be generally divided into bidders from the same bundle and bidders from a different bundle. The bidders from the same bundle may be further divided according to membership criteria (e.g., most recent bidders in the bundle and most active bidders in the bundle). The bidders from different bundles may be similarly divided.

FIG. 2B is a flow diagram illustrating a method of updating a set of active recent bidders according to an embodiment of the invention. The avatars displayed in active recent bidder region 101 of FIG. 1 correspond to the bidders currently in the set of active recent bidders. In one embodiment, ordering of the set of active recent bidders determines which slot in the active recent bidder region 101 the bidder's avatar appears in. For example, in FIG. 1, bidder A appears in the “first” slot (slot 103) of the bidder region 101. This indicates that bidder A is the first-ranked bidder in the set of active recent bidders. The method illustrated in FIG. 2B may be performed in response to each bid received in the auction or each time a time interval elapses. The method may also be performed according to how frequently the data processing system(s) hosting the auction is capable of performing the method.

At block 211, the method ranks each bidder participating in the auction according to how recently each bidder submitted a bid. For example, if the most recent bidder was bidder A, and the second most recent bidder was bidder C, and the third most recent bidder was bidder B, then the ranked list of recent bidders would be A, C, B.

At block 213, the method generates an updated set of active recent bidders using the ranked bidders. For example, the updated set may include a predetermined number of bidders. The size of the set may be determined by the size of the active recent bidder region 101. If the active recent bidder region 101 has ten slots, the set would have ten members.

In one embodiment, the size of the active recent bidder region (and therefore the set of active recent bidders) may be modified in response to the number of bidders participating in the auction. For example, if four bidders are participating in the auction, the active recent bidder region may include four slots. If thirty bidders are participating in the auction, the active recent bidder region may include thirty slots, or the active bidder region may be limited to a number of slots less than the total number of participating bidders, such as ten. The size of the active recent bidder region may be modified during an auction (e.g., as the number of participating bidders changes).

A participating bidder may be defined as a bidder who has submitted one or more bids during the auction. A participating bidder may also be defined as a bidder who has submitted at least one bid within a period of time. For example, a bidder may cease to be considered a participating bidder if the bidder does not submit a bid within one minute prior to the method illustrated in FIG. 2B being performed. In this way, bidders that are not actively involved in the auction (i.e., have bid recently) may be excluded from determining the size of the active recent bidder region.

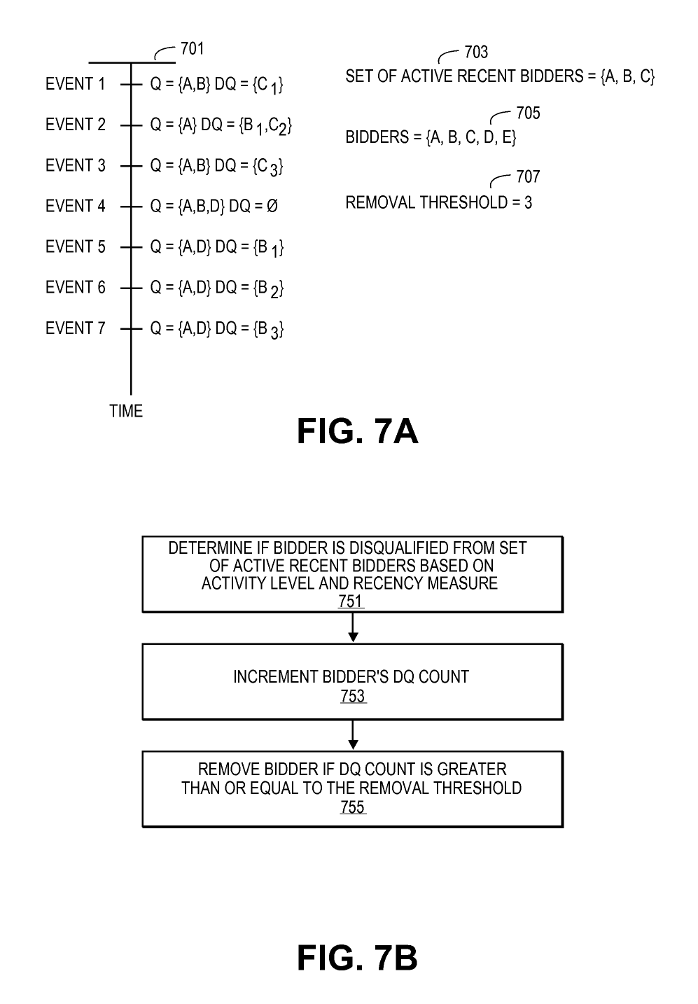

At block 215, the method generates a set of membership transitions by identifying differences between the updated set of active recent bidders and the previous set of active recent bidders. The set of membership transitions define how the updated set of active recent bidders has changed from the previous set of active recent bidders. In one embodiment, three transitions are possible: (1) an “add” transition in which a bidder who was not a member of the previous set of active recent bidders has been added to the updated set of active recent bidders; (2) a “remove” transition in which a bidder who was a member of the previous set of active recent bidders has been removed from the updated set of active recent bidders; and (3) a “reorder” transition in which a bidder who was a member of a first rank in the previous set of active recent bidders has been moved to a second rank in the updated set of active recent bidders. The set of membership transitions is described in greater detail below in conjunction with FIG. 8.

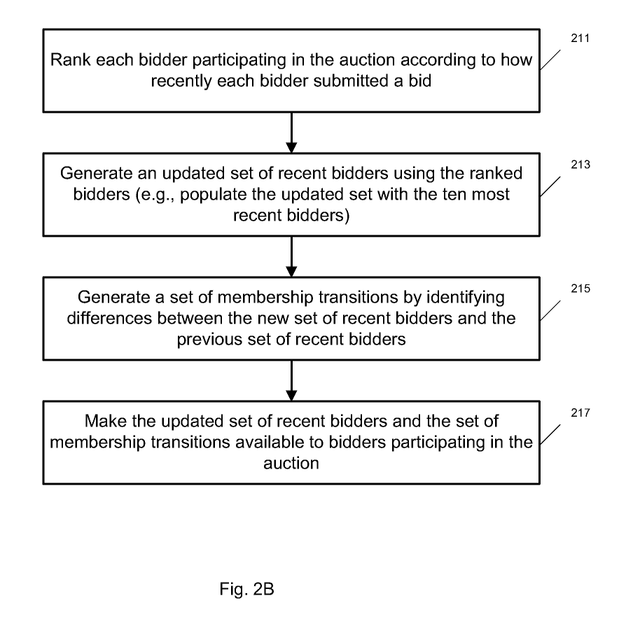

At block 217, the method makes the updated set of active recent bidders and the set of membership transitions available to bidders participating in the auction. In one embodiment, a package of data is transmitted to the system of each bidder participating in the auction. This package may include the updated set of active recent bidders and the set of membership transitions. The updated set of active recent bidders may provide data about each member of the set, such as a link to a media file corresponding to the avatar of that bidder, the rank of the bidder in the set, textual data (e.g., bidder name), and other information. The set of membership transitions may provide each bidder system with information enabling the bidder system to update the active recent bidder region, which is described in greater detail below in conjunction with FIG. 3.

FIG. 2C is a flow chart illustrating a method for updating membership in a set of active recent bidders. At block 221, the method receives an event indicating to evaluate each bidder in a set of active recent bidders. This event may correspond to the end of a time interval. For example, an event may occur every 5 seconds. Other time intervals are also possible. The event may be generated by a certain number of bid(s) being submitted. For example, an event may occur after every 5 bids. The frequency of the event may vary depending on auction conditions. For example, as the number of bids received per minute increases, the event may be generated less often to reduce the frequency of modification of the graphical elements corresponding to the set of active recent bidders. The frequency of the event may also be modified based on the current price of the item, the total number of bids received, the number of active bidders in the auction, the amount of time remaining in the auction, the total elapsed time of the auction so far, etc. The event may be implemented as a function callback or other event handling structure known in the art. Flow moves from block 221 to block 223.

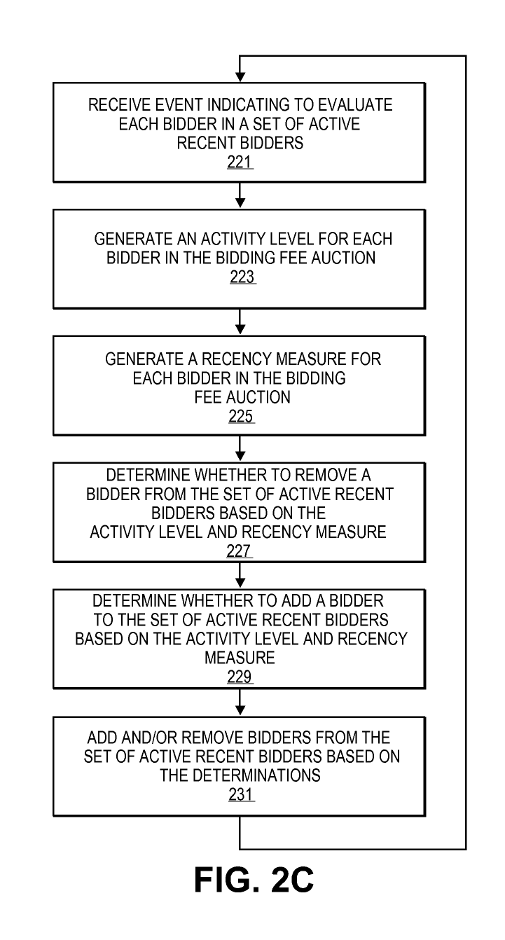

At block 223, the method generates an activity level for each bidder in the bidding fee auction. The activity level may correspond to an overall level of activity throughout the auction. Generation of activity levels is described in greater detail below in conjunction with FIG. 4. At block 225, the method generates a recency measure for each bidder in the bidding fee auction. The recency measure corresponds to how recently the bidder has submitted a bid relative to the time of the event. Time of the event may be the time when the event was received or the time when the event was generated. For example, if a bidder submits a bid three seconds before the time of the event, the recency measure is 3. In other embodiments, the recency measure may be in milliseconds or other unit of time. Generation of recency measures is also described in greater detail below in conjunction with FIG. 4.

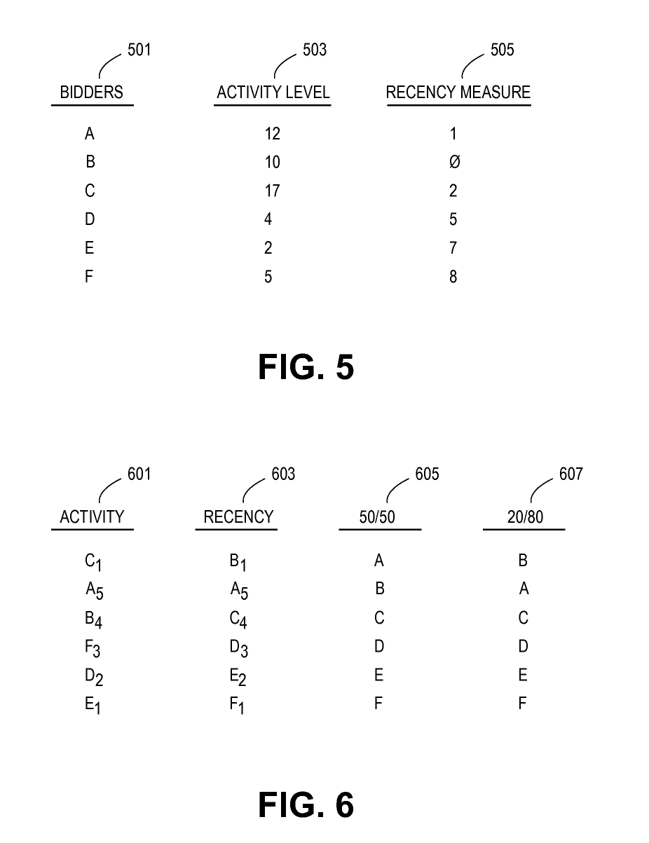

At block 227, the method determines whether to remove a bidder from the set of active recent bidders. Generally, bidders are removed from the set of active recent bidders when the activity level and recency measures of the bidder drop below a threshold for more than a period of time or events. Removal of bidders from the set of active recent bidders is described in greater detail below in conjunction with FIGS. 7A and 7B.

At block 229, the method determines whether to add a bidder to the set of active recent bidders based on the activity level and recency measures of the bidders participating in the bidding fee auction. Generally, bidders are added to the set of active recent bidders when the set of active recent bidders has an open slot due to removal of a bidder from the set or at the beginning of an auction. A bidder may also be added to the set of active recent bidders if the bidder is a current winner of the auction but is not in the set of active recent bidders. In one embodiment, a current winner is guaranteed membership in the set of active recent bidders. Guaranteed membership is described in greater detail below in conjunction with FIG. 7C.

At block 231, bidders are added and/or removed from the set of active recent bidders based on the determinations at blocks 227 and 229. After block 231 is complete, the method returns to block 221 when it receives the next event. This enables the method to continue updating the said of active recent bidders over time as events are received.

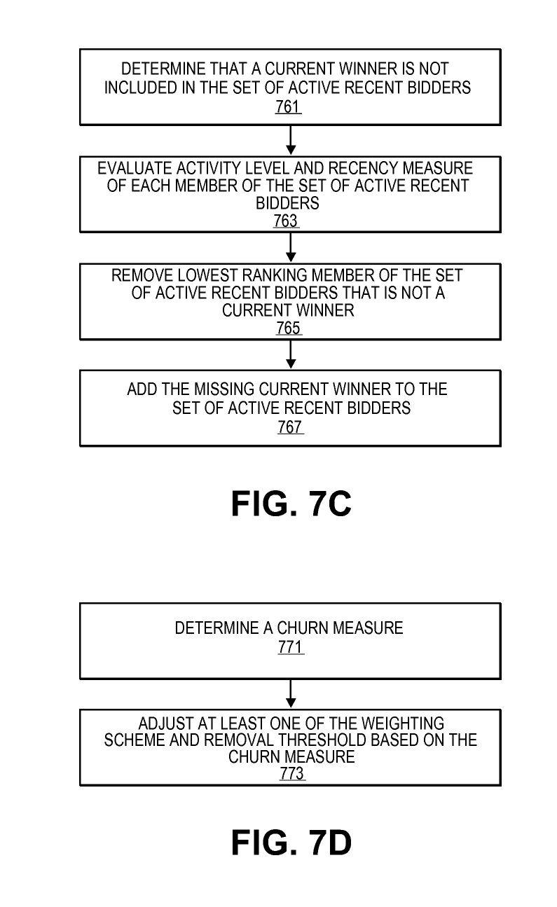

FIG. 3 is a flow chart illustrating a method of updating the active recent bidder region. This method may be performed by a system of a bidder participating in an auction. At block 301, the method receives an updated set of active recent bidders and a set of membership transitions. These sets may be provided by an auction server or system. At block 303, the method applies the set of membership transitions to avatars in the active recent bidder region, as described below in conjunction with FIG. 9. After the method finishes, the avatars displayed in the active recent bidder region corresponds to the updated set of active recent bidders.

In another embodiment, the auction server generates the updated set of active recent bidders and transmits the updated set to individual bidder systems. The bidder system generates the set of membership transitions by comparing the updated set of active recent bidders with the previous set of active recent bidders used by the bidder system. In this embodiment, the bidder system generates the set of membership transitions and applies the set of membership transitions.

FIG. 4 is a diagram illustrating evaluations of bidder volume and bid recency. Timeline 401 illustrates the occurrence of bids in the auction. Chart 403 illustrates the activity level and the recency measure of each bidder based on the bid history of timeline 401. Activity level may be defined as bid volume and corresponds to how many bids a bidder has submitted in the auction or a period of time. For example, bidder 1 has an activity level of 3 because bidder 1 has submitted 3 bids since the auction started. Recency measure may be defined as how recently a bidder has submitted a bid, relative to the time at which the recency measure is determined. For example, bidder 1 has a recency measure of zero, indicating that bidder 1 submitted a bid at substantially the end of the interval at which the recency measure is determined. The activity level may be used to rank bidders according to bid volume, which in turn may be used to control the contents of bidder volume region 119. The recency measure may be used to rank bidders in the set of active recent bidders, which may be used to control the contents of active recent bidder region 101.

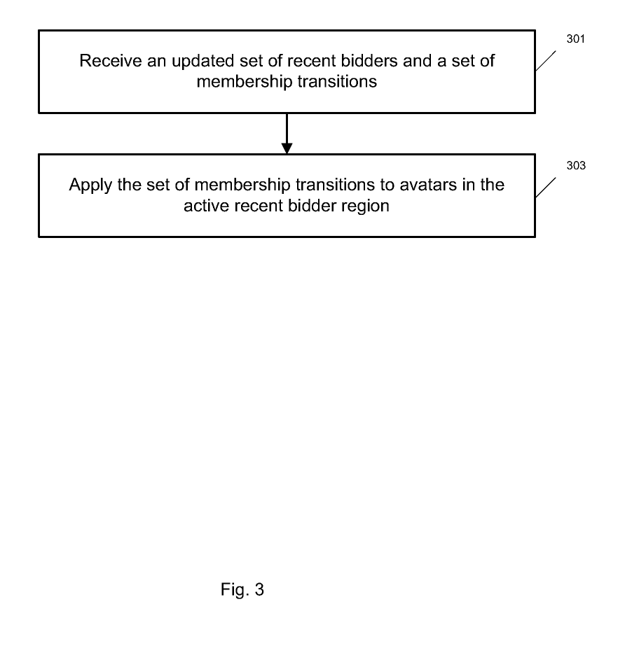

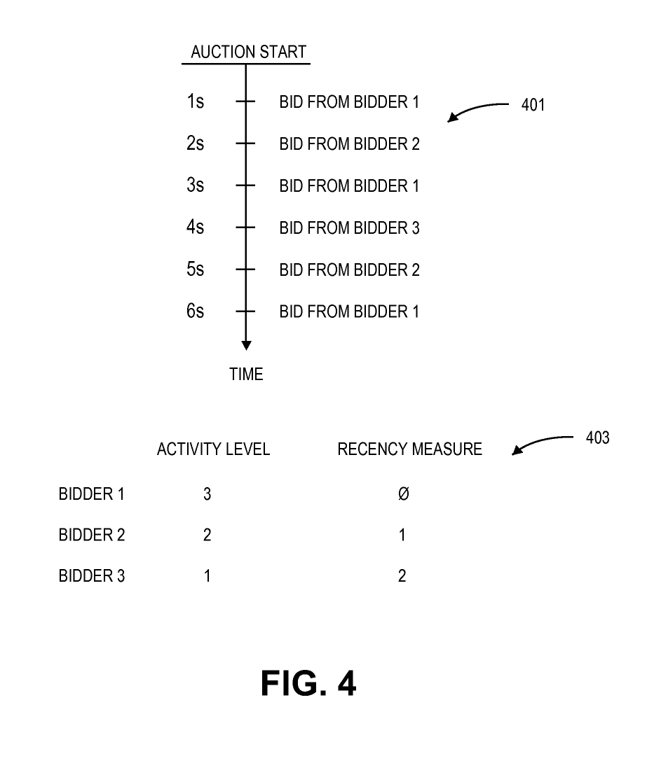

FIGS. 5 and 6 are diagrams illustrating a more complex example of evaluating bidders. Columns 501, 503, and 505 correspond to the bidders involved in the auction, their activity level, and their recency measures, respectively. Bidder C, for example, has an activity level of 17, indicating that bidder C has submitted 17 bids during this auction. Bidder C has a recency measure of 2, indicating that bidder C has not submitted a bid for approximately 2 seconds at the time this recency measure was generated.

Although activity level and recency measure are two ways of evaluating a bidder, they may not be equally valuable in determining whether to qualify the bidder for membership in the set of active recent bidders. FIG. 6 illustrates a pair of weighting schemes to modify the impact of the activity level and the recency measure. Column 601 is a list of the bidders from FIG. 5 sorted according to activity level. Bidder C, having submitted the most bids, is at the top of the list. Column 603 is a list of the bidders from FIG. 5 sorted according to recency measure. Column 605 is a list of the bidders from FIG. 5 sorted according to activity level and recency measure where the two are equally weighted. Column 607 is a list of the bidders from FIG. 5 sorted according to activity level and recency measure, where activity level receives a 20% weighting and recency measure receives an 80% weighting. The order of column 605 and column 607 differs due to the different weighting. Other weightings may be used as well. In other embodiments, the characteristics used to evaluate each bidder and the weighting scheme used to balance the characteristics may change depending on auction conditions. For example, as the bid volume (e.g., bids per minute) of an auction increases, the emphasis on recency measure may be decreased in favor of the emphasis on activity level. Other modifications may be used as well.

In one embodiment, the slots in the active bidder region and the corresponding slots in the set of active recent bidders may be divided into groups according to their membership criteria. For example, a set of active recent bidders may include ten slots. Five slots may be weighted toward the recency measure of the bidder and the other five slots may be weighted toward the activity level of the bidder. The first five slots may assign an 80% weighting to the recency measure, while the second five slots may assign an 80% weight to the activity level. In another embodiment, one or more slots may be designated for displaying current winners of the auction, while the remaining slots may be divided by membership criteria. For example, the active bidder region and corresponding set of active recent bidders may include one slot reserved for a current winner, regardless of activity and recency, six slots weighted toward recency, and six more slots weighted toward activity level. Other distributions are also possible.

The bidder attributes and their associated weighting scheme produce an evaluation of each bidder participating in the bidding fee auction. FIGS. 7A and 7B illustrate the removal and addition of bidders to and from the set of current active bidders. FIG. 7A illustrates a time line over which the membership of the set of active recent bidders changes based upon bidder evaluation. Active recent bidders 703 initially contains three bidders. Bidders 705 initially contains the 5 bidders participating in the auction. Removal threshold 707 indicates that a member of the set of active recent bidders may receive three consecutive disqualifying evaluations before being removed from a set of active recent bidders. Timeline 701 illustrates seven different events and a corresponding state of each member of the set of active recent bidders. After evaluation at event 1, bidders A and B qualify for membership in this set of active recent bidders. However, bidder C receives a disqualifying evaluation. At event 2, bidders B and C receive disqualifying evaluations. At event 3, only bidder C receives a disqualifying evaluation. Since this is the third consecutive disqualifying evaluation received by bidder C, bidder C is removed from the set of active recent bidders during the processing of event 3. In other embodiments, bidder C may be removed at the beginning of the processing of event 4. At events 5 and 6, bidder B receives 2 or more disqualifying evaluations. However, since these disqualifying evaluations are not consecutive with the disqualifying evaluation received at event 2, bidder B is not removed at event 6. At event 7, bidder B receives a third consecutive disqualifying evaluation and will be removed.

FIG. 7B is a flow chart illustrating a method of determining whether to remove a bidder from the set of active recent bidders. At block 751, the method determines if a bidder is disqualified from the set of active recent bidders based on an activity level and a recency measure of the bidder. In one embodiment, this determination is performed in response to each event. At block 753, the method increments the bidder's disqualification count based on the determination. This can be seen in FIG. 7A in the subscripts of members of a disqualified set in timeline 701. For example, after processing event 1 a disqualified set includes bidder C with the subscript of 1. This indicates that bidder C has been disqualified for one consecutive event. At block 755, the method removes the bidder if the disqualification count is greater than or equal to a removal threshold. In other embodiments, the method may remove the bidder if the disqualification count is greater than the removal threshold. The conditional removal of block 755 can be seen in the difference between the disqualified sets corresponding to events 3 and 4 of timeline 701. After processing event of 3, the disqualified set includes bidder C with a subscript of 3 indicating that bidder C has been disqualified for 3 consecutive events. Since removal threshold 707 is equal to 3, the method illustrated in FIG. 7B will remove bidder C during the processing of event 3.

In at least one embodiment, the value of the removal threshold changes over the course of the bidding fee auction. The change occurs in response to changes in characteristics of the auction, such as bid volume over time, total bids submitted, total bidders participating in the auction, etc. Modification of the removal threshold can be used to control what is displayed in active recent bidder region 101 of FIG. 1. The removal threshold influences the frequency with which members of the set of active recent bidders are removed during the auction.

In one embodiment, the bid or service being auctioned is extremely valuable or otherwise highly desirable to a large group of people and may be considered a “once in a lifetime” opportunity. In this example, a high bid volume is likely because many people would like to win the good or service (e.g., a concert). Depending on the removal threshold and the qualification and disqualification evaluations, the active bidder region 101 may be updated frequently. If the region 101 is updated too frequently, the value of having the region 101 may be reduced. Elements displayed in the region 101 may be displayed for so little time that the bidder obtains little benefit from the region 101. This concept may be referred to as excessive “churn.”

FIG. 7D is a flow chart illustrating a method of adjusting membership in the set of active recent bidders. At block 771, the method determines a churn measurement. The churn measurement may be the number of changes per minute to the set of active recent bidders. At block 773, the method adjusts the current weighting scheme and/or the removal threshold. The adjustments may include using new values determined using empirical analysis of auctions. In yet another embodiment, an administrator may specify these values for a given auction. These changes may be made automatically in real time as an auction is occurring.

FIG. 8 is a diagram illustrating an example of a set of membership transitions. Previous set of active recent bidders 801 and updated set of recent bidder 803 are used to derive the set of membership transitions 805. In one embodiment, the set of membership transitions includes four entries for each bidder: a bidder identifier, a type of transition, a transition start, and a transition end. The bidder identifier identifies the transitioning bidder (e.g., bidder A). The transition type indicates the type of transition (e.g., add, remove, reorder, etc.). The transitions start and end indicate, depending on the type of transition, the start and end points of the transition. For example, a remove transition has a starting point corresponding to the current rank of the removed bidder in the previous set of active recent bidders. For bidder A, the transition start is slot 1, since bidder A was the first-ranked bidder in the previous set of active recent bidders. The transition end for bidder A is “off-screen,” indicating that bidder A is not a member of the updated set of active recent bidders. These transitions may be animated or otherwise indicated to a bidder through the graphical user interface of the bidder system, as described below in conjunction with FIG. 9. As another example, reorder transitions may response to increases and decreases in the activity and recency levels of a bidder. As a bidder becomes more active, the bidder may transition into a higher ranking slot and vice versa. The reorder transition may produce different results in embodiment using different membership criteria for different slots.

FIG. 9 is a flow chart illustrating a method of applying a set of membership transitions to the active recent bidder region in the graphical user interface of a bidder system. At block 901, the method receives a set of membership transitions. In one embodiment described below, applying the set of membership transitions comprises displaying various animations of the avatars in the active recent bidder region.

At block 903, the method applies transitions of type “remove.” The method displays an animation in which the avatar corresponding to the transitioning bidder moves from a slot in the active recent bidder region to a location outside the active recent bidder region. For example, the avatar of the transitioning bidder may be animated such that the avatar “flies” from its previous position in the active recent bidder region to a location off the screen of the bidder system. The velocity and acceleration of the avatar may be tuned to aid the bidder's perception of the avatar's movement. In one embodiment, if the bidder using the bidder system is removed from the active recent bidder region, the avatar may “fly” from the previous position of the avatar in the active recent bidder region to the user media 129 to make it more clear to the bidder that the bidder has been removed from the active recent bidder region. Other types of animated removal are also possible.

At block 905, the method applies transitions of type “add.” The method displays an animation in which the avatar corresponding to the transitioning bidder moves from a location outside the active bidder region to an open slot in the active recent bidder region. If the bidder using the bidder system has been added to the active recent bidder region, the avatar may appear to “fly” from the user media 129 into an empty slot in the active recent bidder region.

At block 907, the method applies transitions of type “reorder.” The method displays an animation in which the avatar corresponding to the transitioning bidder moves from a current slot in the active recent bidder region to a new slot in the active recent bidder region. For example, the avatar may “fly” from slot 4 to slot 2.

The various animated transitions may be combined into a single animation. For example, an avatar of a bidder being removed may fly off-screen as a bidder being added flies into the slot from which the bidder being removed previously inhabited. In another example, two reorder transitions may be combined. If a first bidder is moving from slot 2 to slot 3, and another bidder is moving from slot 3 to slot 2, the animation may appear as a simultaneous “swap” in which the two avatars fly to their new slots simultaneously.

In one embodiment, the set of membership transitions is generated by the auction server and provided, along with the updated set of active recent bidders, to the bidder system. In another embodiment, the set of membership transitions is generated by the bidder system by comparing the updated set of active recent bidders to the previous set of active recent bidders.

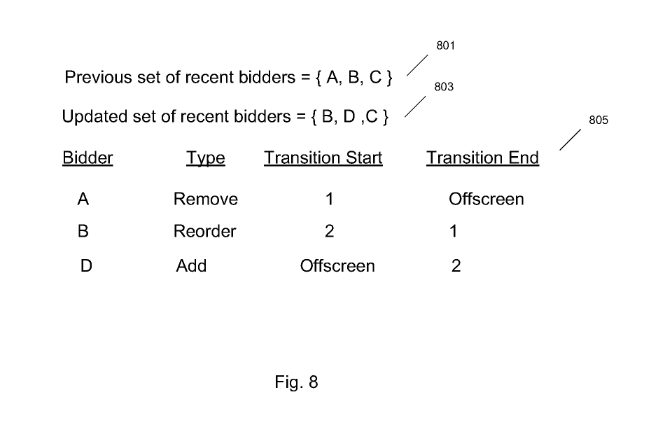

FIG. 10 shows one example of a data processing system which may be used with one embodiment the present invention. Note that while FIG. 10 illustrates various components of a computer system, it is not intended to represent any particular architecture or manner of interconnecting the components as such details are not germane to the present invention. It will also be appreciated that network computers, tablet computers, and other data processing systems which have fewer components or perhaps more components may also be used with the present invention.

As shown in FIG. 10, the computer system 1000, which is a form of a data processing system, includes a bus 1003 which is coupled to a microprocessor(s) 1005 and a ROM (Read Only Memory) 1007 and volatile RAM 1009 and a non-volatile memory 1011. For example, the non-volatile memory 1010 may be a machine-readable non-transitory storage medium. The microprocessor 1005 is coupled to cache 1004. The microprocessor 1005 may retrieve the instructions from the memories 1007, 1009, 1011 and execute the instructions to perform operations described above. The bus 1003 interconnects these various components together and also interconnects these components 1005, 1007, 1009, and 1011 to a display controller and display device 1013 and to peripheral devices such as input/output (I/O) devices which may be mice, touch screens, touch pads, touch sensitive input devices, keyboards, modems, network interfaces, printers and other devices which are well known in the art. Typically, the input/output devices 1015 are coupled to the system through input/output controllers 1017. The volatile RAM (Random Access Memory) 1009 is typically implemented as dynamic RAM (DRAM) which requires power continually in order to refresh or maintain the data in the memory.

The mass storage 1011 is typically a magnetic hard drive or a magnetic optical drive or an optical drive or a DVD RAM or a flash memory or other types of memory systems which maintain data (e.g., large amounts of data) even after power is removed from the system. Typically, the mass storage 1011 will also be a random access memory although this is not required. While FIG. 10 shows that the mass storage 1011 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 1003 may include one or more buses connected to each other through various bridges, controllers and/or adapters as is well known in the art.

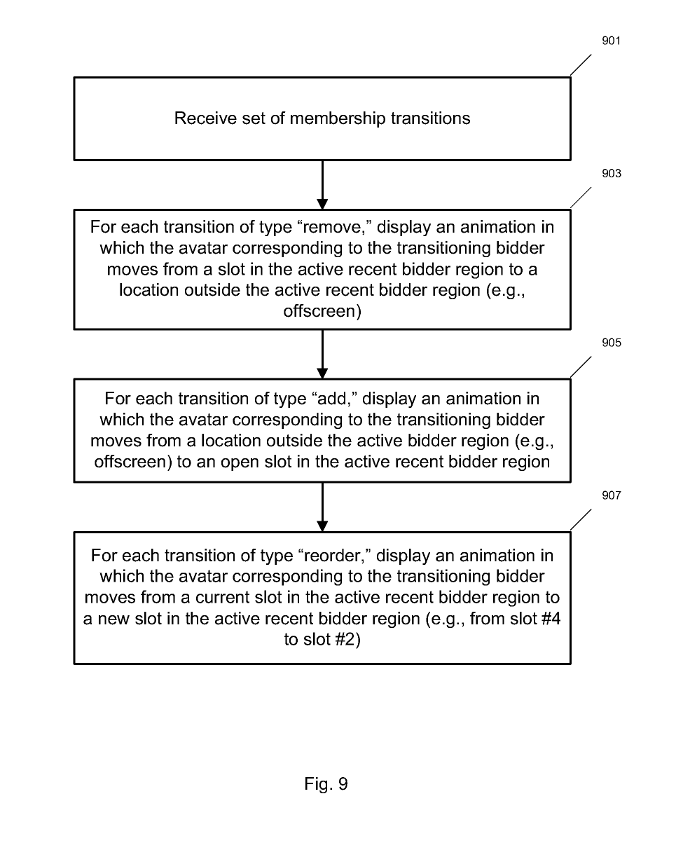

FIG. 11 shows an example of another data processing system which may be used with one embodiment of the present invention. The data processing system 1100 shown in FIG. 11 includes a processing system 1111, which may be one or more microprocessors, or which may be a system on a chip integrated circuit, and the system also includes memory 1101 for storing data and programs for execution by the processing system. The system 1100 also includes an audio input/output subsystem 1105 which may include a microphone and a speaker for, for example, playing back music or providing telephone functionality through the speaker and microphone.

A display controller and display device 1107 provide a visual bidder interface for the bidder; this digital interface may include a graphical bidder interface which is similar to that shown on a Macintosh computer when running OS X operating system software. The system 1100 also includes one or more wireless transceivers 1103 to communicate with another data processing system, such as the system 1000 of FIG. 10. A wireless transceiver may be a WiFi transceiver, an infrared transceiver, a Bluetooth transceiver, and/or a wireless cellular telephony transceiver. It will be appreciated that additional components, not shown, may also be part of the system 1100 in certain embodiments, and in certain embodiments fewer components than shown in FIG. 11 may also be used in a data processing system.

The data processing system 1100 also includes one or more input devices 1113 which are provided to allow a bidder to provide input to the system. These input devices may be a keypad or a keyboard or a touch panel or a multi touch panel. The data processing system 1100 also includes an optional input/output device 1115 which may be a connector for a dock. It will be appreciated that one or more buses, not shown, may be used to interconnect the various components as is well known in the art. The data processing system shown in FIG. 11 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device. In other embodiments, the data processing system 1100 may be a network computer or an embedded processing device within another device, or other types of data processing systems which have fewer components or perhaps more components than that shown in FIG. 11.

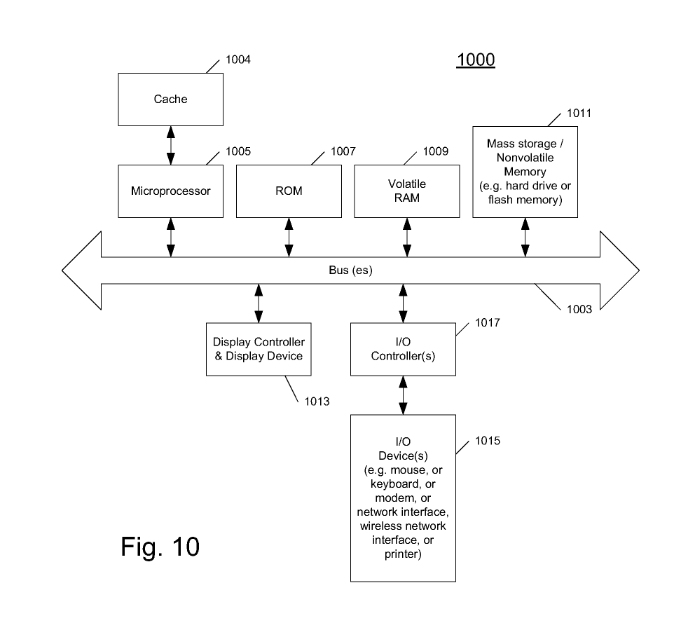

Different variations on the active recent bidder region 101 may be used for different auctions. FIG. 12 is a diagram illustrating a linear embodiment of an active recent bidder region. Media 1201 may be graphics, text, or video describing the good or service being auctioned. Below media 1201 is the active recent bidder region. Avatar dimension 1203 corresponds to the height of an avatar (i.e., graphical bidder element) corresponding to a member of the set of active recent bidders. In one embodiment, the aspect ratio of the avatar is fixed, so a change to the height of the avatar causes a change to the width and vice versa. Each horizontal row of avatars in the active recent bidder region may be referred to as a rank. Intra-rank spacing 1205 corresponds to a measure of distance between the avatars in a rank. Inter-rank spacing 1207 corresponds to a measure of distance between avatars in different ranks. As illustrating in FIG. 12, inter-rank spacing 1207 measures the vertical distance between avatars, while intra-rank spacing 1205 measures the horizontal distance between avatars. In other embodiments, ranks may be defined differently.

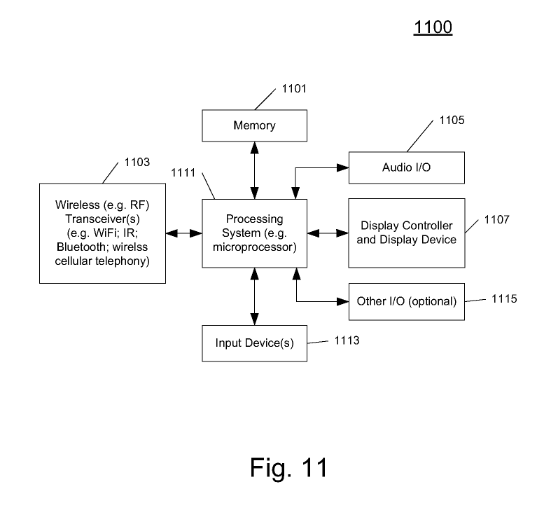

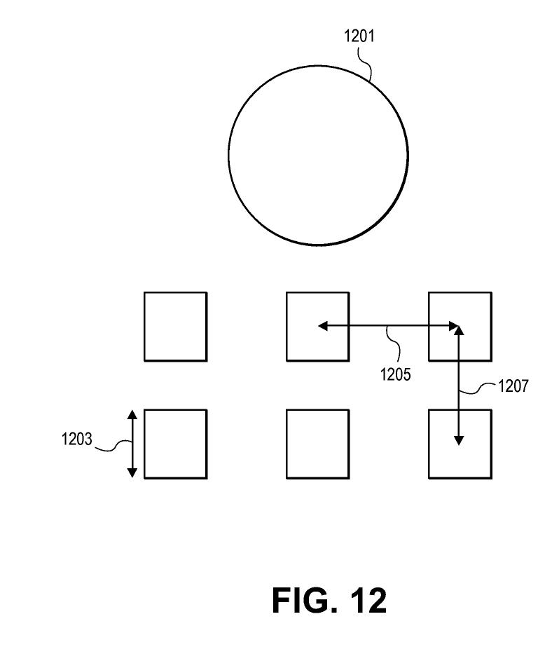

FIG. 13 is a diagram illustrating intra-rank spacing in a radial embodiment of an active recent bidder region. Intra-rank spacing 1301 measures, using an arc, the separation between avatar 1303 and avatar 1305. FIG. 14 is a diagram illustrating an active arc of a radial embodiment of an active recent bidder region. Media 1401 corresponds to the good or service being auctioned and is at the origin of the active arc. The active arc 1403 specifies the size of the active recent bidder region. Avatar 1405 is an outermost avatar in active bidder region specified by arc 1403.

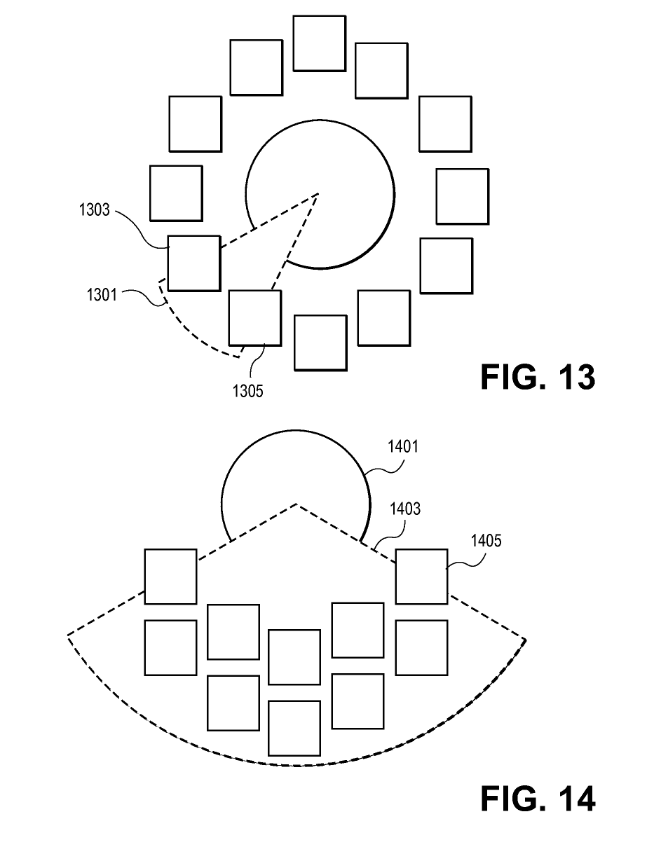

FIGS. 15-18 are diagrams illustrating variations on a linear embodiment of an active recent bidder region. Four layout attributes of the active recent bidder region are considered in these Figures: (1) inter-rank spacing; (2) intra-rank spacing; (3) avatar size; and (4) rank size. In these Figures, ranks are illustrated horizontally. Intra-rank spacing 1501 corresponds to the horizontal distance between avatars in a rank. Inter-rank spacing 1503 corresponds to the vertical distance between avatars in different ranks. Avatar size 1505 corresponds to the size of an avatar in a rank. Rank size corresponds to the number of avatars in a rank. In FIG. 15, all four layout attributes are constant between ranks, so each rank includes the same number of avatars, each avatar of the same size, each avatar equally spaced from other avatars.

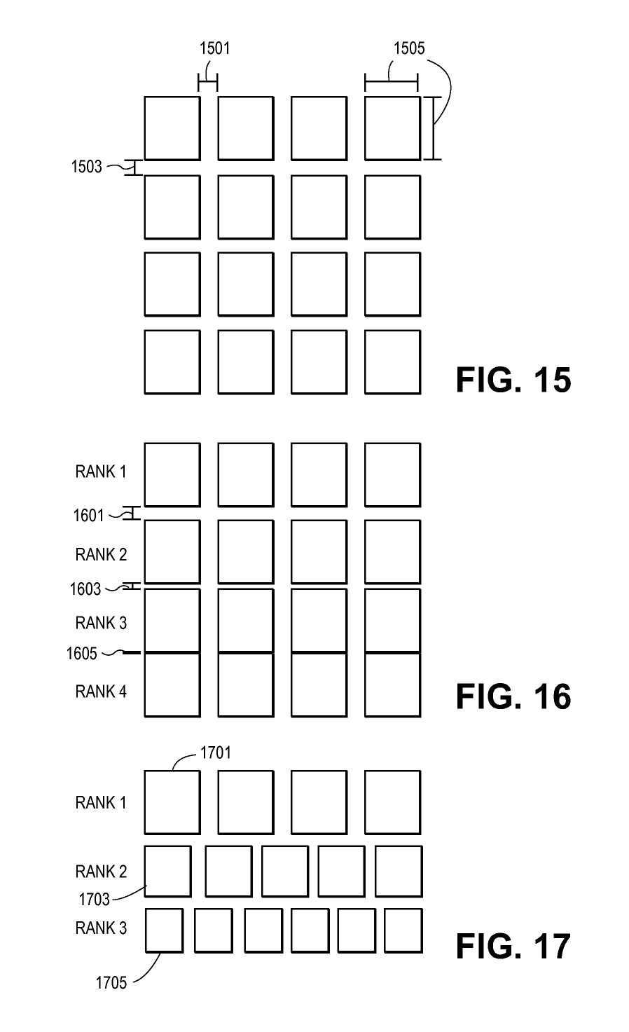

FIG. 16 is a diagram illustrating a linear embodiment of an active recent bidder region in which the inter-rank spacing is linearly decreased, while the other layout attributes remain constant. The inter-rank spacing decreases from the top down. The inter-rank spacing 1601 between ranks 1 and 2 is larger than inter-rank spacing 1603 between ranks 2 and 3, and inter-rank spacing 1605 between ranks 3 and 4 is larger than the inter-rank spacing 1603.

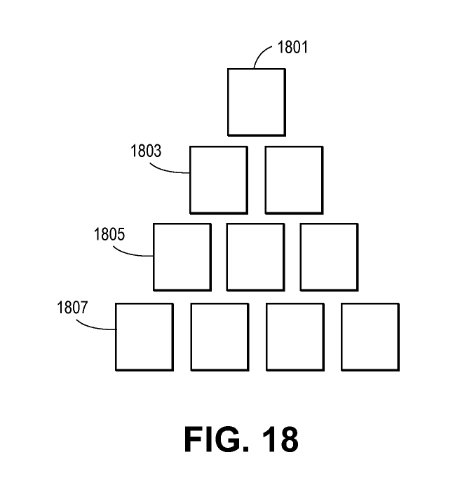

FIG. 17 is a diagram illustrating a linear embodiment of an active recent bidder region in which the inter-rank spacing and the avatar-size are both linearly decreasing, while the intra-rank spacing and the rank size are held in proportion to the inter-rank spacing and the avatar size. Avatar 1701 in rank 1 is larger than avatar 1703 in rank 2 and avatar 1703 is larger than avatar 1705 in rank 3. The intra-rank spacing of rank 1 is proportional to the size of the avatar 1701. As the avatar size decreases from top to bottom, the rank size increases since more avatars are able to fit in the rank when the avatars are smaller.

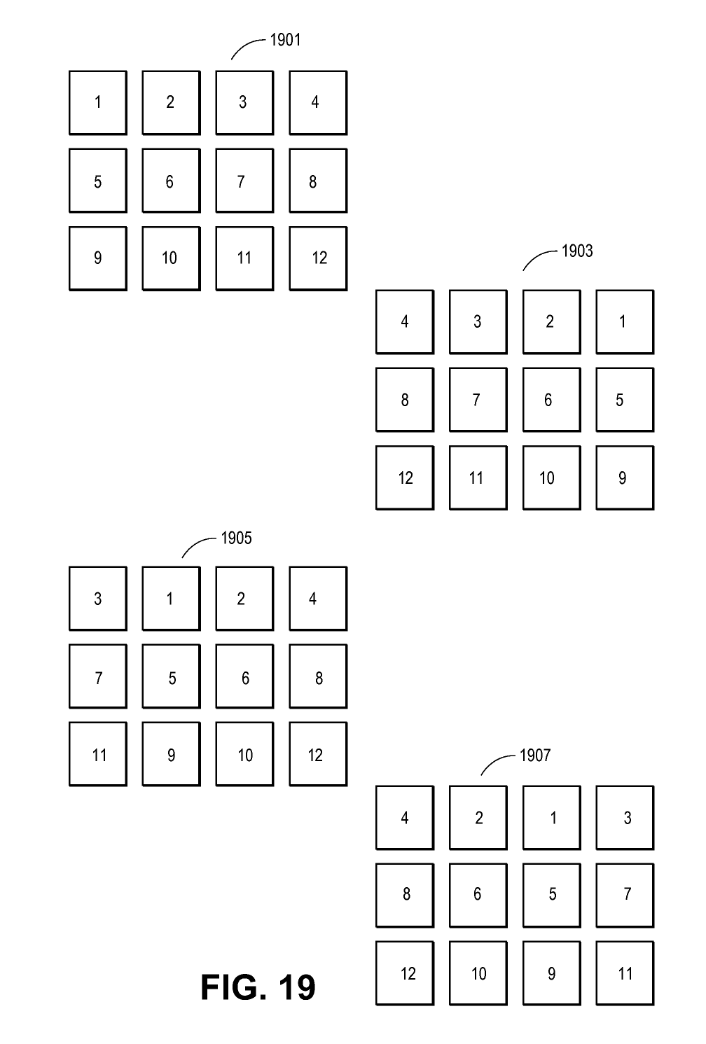

FIG. 18 is a diagram illustrating a linear embodiment of an active recent bidder region in which the rank size increases linearly. Rank 1 includes a single avatar; rank 2 includes two avatars; rank 3 includes three avatars; and rank 4 includes 4 avatars. Intra-rank spacing, inter-rank spacing, and avatar size remain constant.

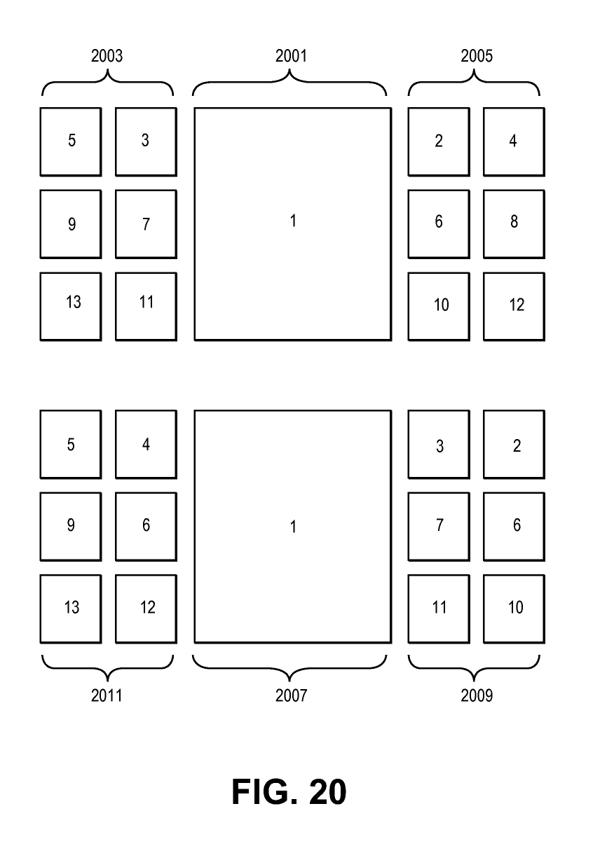

FIG. 19 is a diagram illustrating four ordering variations of a linear embodiment of an active recent bidder region. In region 1901, the ordering is linear and runs from left to right and then descends one rank. In region 1903, the ordering is also linear but runs from right to left and then descends one rank. In region 1905, the ordering alternates from left to right, while in region 1907, the ordering alternates from right to left.

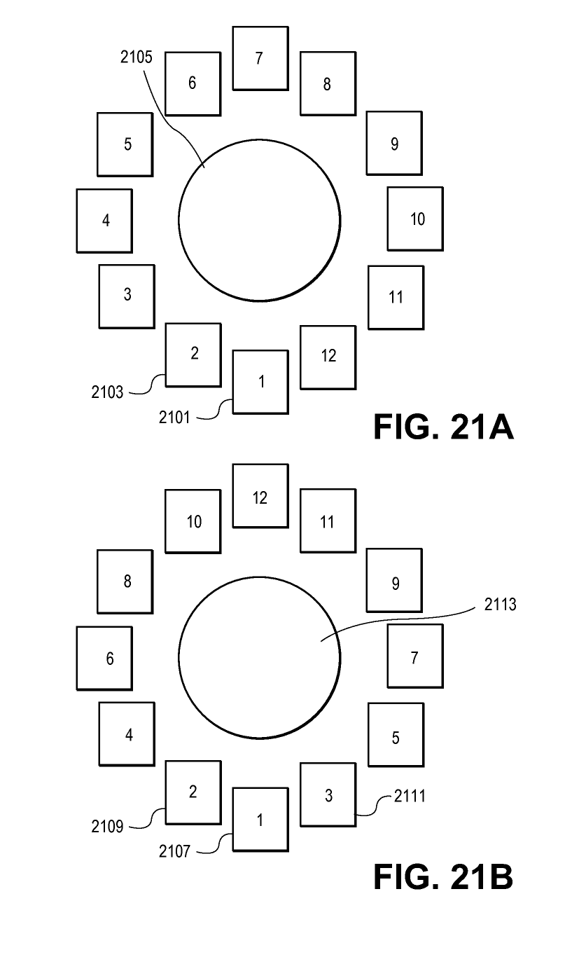

FIG. 20 illustrates two ordering variations of a linear embodiment of an active recent bidder region with a distinguished current winner. The avatar 2001 of the current winner in the first region is larger than the other bidder avatars 2003 and 2005. The bidders corresponding to the avatars in 2001, 2003, and 2005 are all members of the set of active recent bidders, however, the bidder corresponding to avatar 2001 is distinguished as the current winner by the size of avatar 2001. The ordering of the avatars in the first region is alternating from right to left. The second active bidder region illustrated in FIG. 20 also distinguishes a current winner using the size of avatar 2007. Avatars 2007, 2009, and 2011 are ordered in a linear fashion from right to left.

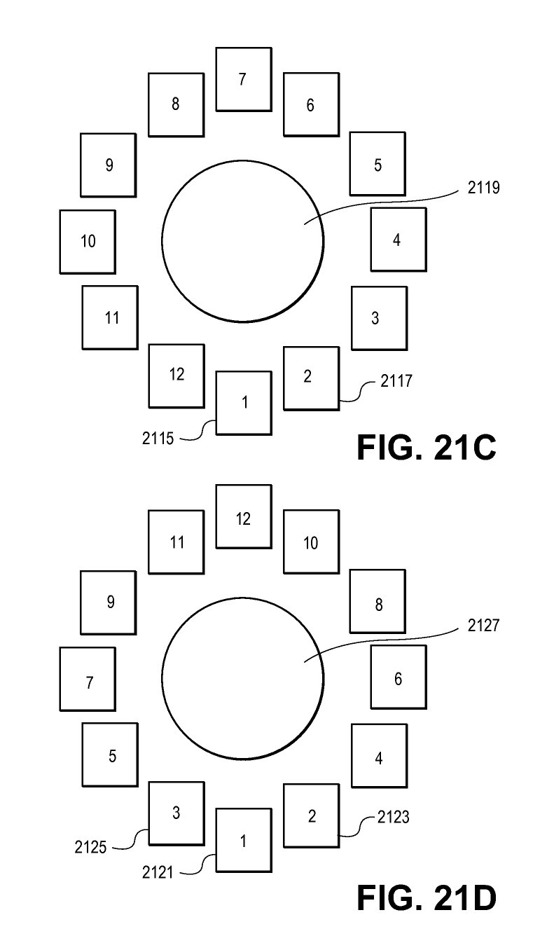

FIGS. 21A-21D illustrate four ordering variations of a radial embodiment of an active recent bidder region. FIG. 21A illustrates a clockwise linear ordering of avatars around a media 2105 corresponding to a good or service being auctioned. Avatar 2103 follows avatar 2101 in a clockwise fashion.

FIG. 21B illustrates an alternating counterclockwise ordering of avatars around a media 2113. Avatar 2107 is in the first position, followed by avatar 2109 clockwise from avatar 2107, alternating to avatar 2111 in the third position, and so on. FIG. 21C illustrates an alternating counterclockwise ordering around media 2119. Avatar 2117 follows avatar 2115 in a counterclockwise direction. FIG. 21D illustrates an alternating counterclockwise ordering in which avatar 2121 is in the initial position, avatar 2123 follows avatar 2121 in a clockwise direction, and avatar 2125 alternates to the other side of avatar 2121. The counterclockwise ordering is centered on media 2127.

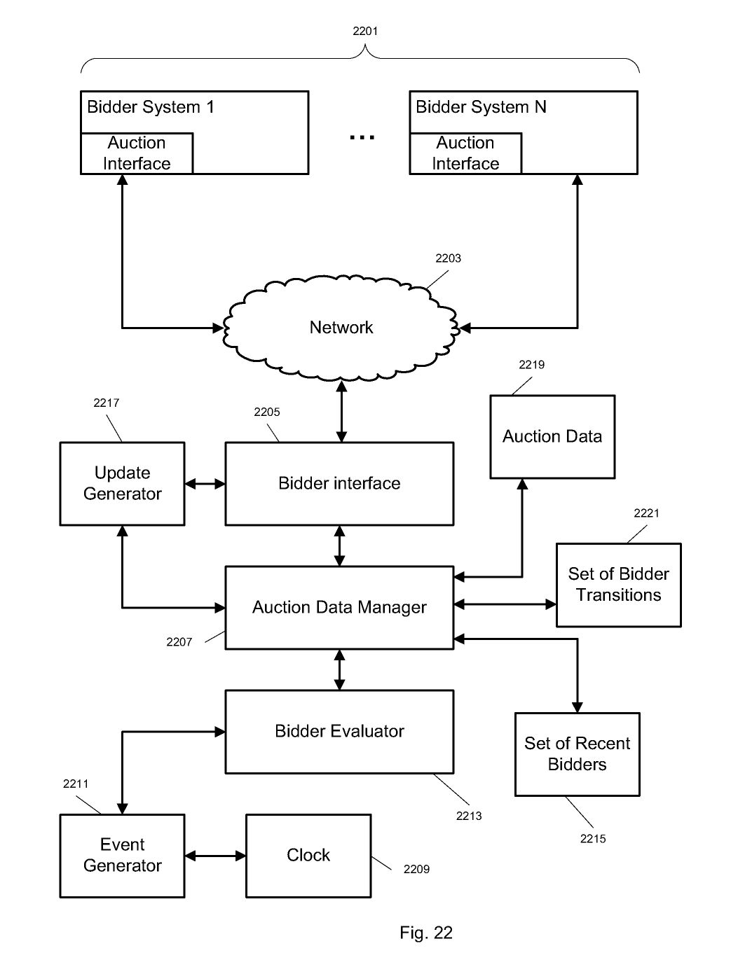

FIG. 22 is a diagram illustrating modules of an embodiment of the invention. Bidder systems 2201 each include an auction interface through which the bidder systems participate and observe an auction. The auction interface may be a web browser. The bidder systems communicate with auction server 2223 through network 2203. Bidder interface 2205 sends and receives auction data to and from the bidder systems 2201 through the network 2203. Bidder interface 2205 receives bids and other data (e.g., login information) from bidders 2201 and passes the data to auction data manager 2207, which in turn updates auction data 2219 to reflect the received data. For example, the data may be a “bid” comprising a bidder identifier and a time at which the bid was submitted. The auction data manager 2207 may add this bid data to auction data 2219, which may be implemented as a database.

Event generator 2211 may generate events based on input from the clock 2209. For example, every twentieth of a second, the event generator may generate an event. The event is sent to bidder evaluator 2213 and cause the evaluator 2213 to request bidder data from auction data manager 2207, which is serviced using auction data 2219. The evaluator 2213 ranks the bidders using the bidder data according to, for example, the recency with which the bidders have submitted bids. This ranked list of bidders may be used by the evaluator 2213 to generate a set of active recent bidders 2215, which the evaluator submits to manager 2219 for storage. The set of active recent bidders 2215 may be stored in the same database as auction data 2219. Evaluator 2213 may also compare an updated set of active recent bidders to a previous set of active recent bidders requested from manager 2219 in order to generate a set of membership transitions 2221. The set of membership transitions 2221 describes the changes between a previous set of active recent bidders and an updated set of active recent bidders as described above.

Evaluator 2213 provides the updated set of active recent bidders and the set of membership transitions to manager 2207. Manager 2207 causes update generator 2217 to prepare a data package including the set of membership transitions 2221 and the set of active recent bidders 2215. Generator 2217 provides the prepared data package to bidder interface 2205, which in turn provides the data package to bidder systems 2201 through network 2203. Each bidder system, in response to receiving the data package, updates the system's auction interface based on contents of the data package. In one embodiment, generator 2217 tailors the data package to groups of bidder systems or individual bidder systems.

The data package received by bidder systems from the auction server may include various data used by the bidder system. For example, the data package may include an updated set of active recent bidders. Elements of the set data structure may include links to images to be used as avatars for the bidder.

In the foregoing specification, displaying active recent bidders in a bidding fee auction has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method of displaying on an electronic display online bidding activity in a bidding fee auction for an item up for bid, the method comprising:
generating, in response to an event, an activity level and a recency measure for each bidder that has submitted at least one bid since a previous event, the activity level indicating a total number of bids submitted by the corresponding bidder and the recency measure indicating how recently the corresponding bidder has bid;
determining, based on the activity level and the recency measure for each bidder, to perform one or more actions of modifying bidder membership in a set of active recent bidders to include only active recent bidders; and
displaying in an active recent bidders region of a graphical bidder interface graphical bidder elements identifying each and only the set of active recent bidders, wherein the active recent bidders region has a maximum number of bidder elements it can display, and wherein the set of active recent bidders includes a currently winning bidder of the bidding fee auction, wherein the set of active recent bidders is less that all of the bidders when the number of bidders exceeds the maximum number of bidder elements.

2. The method of claim 1, further comprising:
modifying the display of at least one graphical bidder element to indicate that the at least one bidder corresponding to the at least one graphical bidder element is a currently winning bidder of the bidding fee auction.

3. The method of claim 2, wherein generating an activity level for each bidder comprises calculating a total number of bids submitted by the corresponding bidder in the bidding fee auction and wherein generating a recency measure for each bidder comprises measuring an amount of time since the corresponding bidder last submitted a bid in the bidding fee auction.

4. The method of claim 3, wherein modifying bidder membership in the set of active recent bidders comprises at least one of removing a bidder from the set, adding a bidder to the set, and changing a position of a bidder within the set.

5. The method of claim 4, wherein determining whether to remove a bidder comprises:
recording whether the activity level or the recency measure disqualifies the bidder from the set of active recent bidders;
calculating a total consecutive number of times the bidder has been disqualified;
removing the bidder from the set of active recent bidders if the total consecutive number of times exceeds a removal threshold; and
removing the graphical bidder element corresponding to the bidder from the active recent bidder region if the bidder is removed from the set of active recent bidders.

6. The method of claim 4, wherein determining whether to add a bidder comprises:
determining whether the activity level and the recency measure qualifies the bidder for addition to the set of active recent bidders;
adding the bidder if the bidder is qualified and the set of active recent bidders has an open slot.

7. The method of claim 5, further comprising:
modifying the removal threshold during the bidding fee auction in response to a change in at least one of total bid volume of the bidding fee auction, current bids per minute of the bidding fee auction, and current time remaining in the bidding fee auction.

8. The method of claim 4, wherein changing a position of a bidder within the set comprises:
modifying a position of the bidder within the set of active recent bidders in response to activity level and the recency measure for each bidder;
causing a graphical bidder element corresponding to the bidder to be displayed in a different position in the active recent bidder region according to the modified position of the bidder in the set.

9. The method of claim 1, wherein a displayed organization of the active recent bidder region corresponds to a type of the item up for bid and wherein the type is a musical concert and wherein the single graphical bidder elements are arranged in a virtual stadium and wherein the at least one single graphical bidder element corresponding to the at least one current winner is displayed in front row seats of the stadium.

10. A machine readable non-transitory storage medium storing instructions which when executed by a processor cause the processor to perform a method of managing display of an active recent bidders region during a bidding fee auction, the method comprising:
generating an initial data structure comprising an initial plurality of graphical bidder display elements, wherein each element corresponds to a member of a set of active recent bidders;
transmitting the initial data structure to a data processing system, wherein the data processing system causes the plurality of graphical bidder display elements to be displayed on a display device coupled to the data processing system;
generating, in response to an event, at least one bidder attribute for a bidder participating in the bidding fee auction;
determining, based on the at least one bidder attribute, that the bidder is disqualified from membership in the set of active recent bidders;
removing the bidder from the set of active recent bidders;
generating a subsequent data structure comprising a subsequent plurality of graphical bidder display elements by removing an element corresponding to the removed bidder from the initial plurality.

11. The medium of claim 10, the method further comprising:
modifying the display of at least one graphical bidder element to indicate that the at least one bidder corresponding to the at least one graphical bidder element is a current winner of the bidding fee auction.

12. The medium of claim 11, wherein modifying the display of at least one graphical bidder element comprises increasing the size of the at least one graphical bidder element relative to other graphical bidder elements displayed in the active bidder region.

13. The medium of claim 10, the method further comprising:
generating an ordered list of bidders participating in the bidding fee auction, wherein the ordering is based on the at least one bidder attribute of each bidder.

14. The medium of claim 13, wherein the ordered list is incorporated into the initial data structure and wherein the initial data structure causes the data processing system to display the plurality of graphical bidder elements in a first arrangement.

14. The medium of claim 14, wherein the first arrangement comprises displaying the plurality of graphical bidder elements in a radial pattern around a center and wherein a graphical representation of a good or service being auctioned is displayed at the center.

15. The medium of claim 14, wherein the first arrangement comprises displaying the plurality of graphical bidder elements in a grid pattern adjacent to a graphical representation of a good or service being auctioned.

16. A method of adjusting a frequency with which a plurality of avatars are displayed on a display device during a bidding fee auction, the method comprising:
modifying, using an initial removal threshold, at the end of a first interval, a set of active recent bidders, wherein each avatar in the plurality of avatars corresponds to one member of the set of active recent bidders;
modifying the plurality of avatars based on the modified set of active recent bidders;
displaying the plurality of avatars in an active recent bidder region of a graphical user interface on the display device;
determining an update frequency of the set of active recent bidders;
modifying the initial removal threshold in response to determining that the update frequency exceeds a churn threshold;
modifying, using the modified removal threshold, at the end of a second interval, the set of active recent bidders.

17. The method of claim 16, wherein modifying the set of active recent bidders comprises removing a bidder from the set of active recent bidders based on an evaluation of the bidder using at least one bidder attribute.

18. The method of claim 18, where modifying the set of active recent bidders further comprises adding a bidder to the set of active recent bidders based on the evaluation.

19. The method of claim 16, wherein the update frequency comprises at least one of (a) an average number of modifications to the set of active recent bidders after each interval and (b) a proportion of intervals that the set of active recent bidders is modified.

20. The method of claim 19, wherein the churn threshold specifies a number of display updates to the plurality of avatars per minute.

21. The method of claim 20, wherein the initial removal threshold causes a bidder to be removed from the set of active recent bidders more frequently than the modified removal threshold.

22. A data processing system comprising:
means for displaying a single graphical bidder element for each bidder in a set of active recent bidders in an active recent bidders region of a graphical bidder interface (GUI);
means for generating, in response to an event, an activity level for each bidder participating in the bidding fee auction;
means for generating, in response to the event, a recency measure for each bidder participating in the bidding fee auction;
means for determining, based on the activity level and the recency measure for each bidder participating in the bidding fee auction, whether to remove a first bidder from the set of active recent bidders and to remove a first single graphical bidder element corresponding to the first bidder from the active recent bidders region;
means for determining, based on the activity level and the recency measure for each bidder in the bidding fee auction, whether to add a second bidder participating in the bidding fee auction to the set of active recent bidders and to display a second single graphical bidder element for the second bidder in the active recent bidders region.

23. The data processing system of claim 22, wherein determining whether to remove a first bidder comprises:
means for recording whether the activity level or the recency measure disqualifies the first bidder from the current set of active recent bidders;
means for calculating a total consecutive number of times the first bidder has been disqualified;
means for removing the first bidder from the current set of active recent bidders if the total consecutive number of times exceeds a removal threshold;
means for removing the single graphical bidder element corresponding to the first bidder from the active recent bidder display region.

24. The data processing system of claim 23, further comprising:
means for modifying the removal threshold during the bidding fee auction in response to a change in at least one of total bid volume of the bidding fee auction, current bids per minute of the bidding fee auction, and current time remaining in the bidding fee auction.

25. The data processing system of claim 24, wherein a displayed organization of the active recent bidder display region corresponds to a type of the item or service being auctioned and wherein the type is a musical concert and wherein the single graphical bidder elements are arranged in a virtual stadium and wherein the at least one single graphical bidder element corresponding to the at least one current winner is displayed in front row seats of the stadium.

26. An apparatus comprising:
a bidder interface module configured to receive bids from a plurality of bidder systems and to transmit data packages to the plurality of bidder systems;
an auction data manager module coupled to the bidder interface module configured to receive the bids from the bidder interface module and to store the bids in an auction data module;
a bidder evaluator module coupled to the auction data manager configured to respond to an event by ranking bidders in the auction data module according to the recency with which the bidders have submitted bids to the bidder interface module and to generate an updated set of active recent bidders from the ranked bidders and to generate a set of membership transitions based on the updated set of active recent bidders and a previous set of active recent bidders;
an update generator module coupled to the auction data manager configured to generate the data packages based on the updated set of active recent bidders and the set of membership transitions;
an event generator module coupled to the bidder evaluator module configured to generate an event to be sent to the bidder evaluator module; and
a clock module coupled to the event generator module configured to provide a clock input to the event generator module.

27. A method for managing display of graphical bidder elements in an online auction interface, the method comprising:
ranking bidders according to a bidder criteria;
modifying a current set of active bidders using the ranked bidders to generate an updated set of active bidders;
updating the display of the graphical bidder elements using the updated set of active recent bidders.

28. The method of claim 27, wherein the bidder criteria is a measure of how recently a bidder has submitted a bid and ranking the bidders comprises ranking the bidders from most recent to least recent.

29. The method of claim 27, wherein modifying the current set of active bidders comprises at least one of removing a bidder from the current set, adding a bidder to the current set, changing a position of a bidder in the current set, and changing a size of the set of active recent bidders.

30. The method of claim 29, wherein updating the display of the graphical bidder elements comprises removing a graphical bidder element corresponding to a bidder removed from the current set.

31. The method of claim 30, wherein updating the display of the graphical bidder elements comprises adding a graphical bidder element corresponding to a bidder added to the current set.

32. The method of claim 31, wherein updating the display of the graphical bidder elements comprises moving a graphical bidder element corresponding to a bidder with a changed position in the current set to a new location in the interface.

33. The method of claim 27, further comprising:
modifying the display of a graphical bidder element to indicate that a bidder corresponding to the graphical bidder element is a currently winning bidder of the auction.

34. A method for displaying graphical user interfaces for an online bidding fee auction where the item up for bid is one-of-a-kind, the method comprising the steps of:
maintaining an activity level and a recency measure for each bidder that has submitted at least one bid for the single one-of-a-kind item of the bidding fee auction, wherein the activity level indicates a total number of bids submitted by the corresponding bidder and the recency measure indicates how recently the corresponding bidder has bid, wherein the per bid fee is less than a penny, wherein the expected number of bids for the single one-of-a-kind item is over one thousand, and wherein the rate at which bids for the single one-of-a-kind item may be placed exceeds an ability to display a bid history in a reasonably viewable manner;
periodically selecting, based on the activity level and the recency measures, as a current display set only active recent ones of the bidders up to a maximum number allowed to be displayed at one time; and
responsive to each of said steps of determining, displaying on each of a plurality of electronic displays a graphical user interface that has an active recent bidder region showing an avatar for each and only the current display set rather than the bid history or currently unselected bidder's avatars, whereby a viewer of one of the graphical user interfaces can discern a current status of the bidding fee auction even though the bid rate at times may not allow for a reasonably viewable bid history to be displayed.

35. The method of claim 34, wherein maintaining an activity level for each bidder comprises calculating a total number of bids submitted by the corresponding bidder in the bidding fee auction and wherein generating a recency measure for each bidder comprises measuring an amount of time since the corresponding bidder last submitted a bid in the bidding fee auction.
